(19) United States
(12) Patent Application Publication
(10) Pub. No.: US 2007/0281231 A1
(43) Pub. Date: Dec. 6, 2007

(54) Toner, toner particle-producing method, image-forming apparatus and image-forming process

(75) Inventor: Akinori Koyama, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/807,948

(22) Filed: May 30, 2007

(30) Foreign Application Priority Data
May 31, 2006 (JP) 2006-151467

(51) Int. Cl. G03G 9/08

(52) U.S. Cl. 430/108.1; 430/110.3; 430/137.21

(57) ABSTRACT

The toner according to the present invention is a toner containing toner particles, comprising microparticle-deposited toner particles carrying polymerization microparticles having a particle diameter of 100 to 2,000 nm deposited on the surface of primary polymerization particles having a particle diameter of 3 to 12 μm in an amount of (80) pieces or more with respect to (100) pieces of the toner particles. It is possible to obtain favorable long-term cleaning efficiency of a photosensitive body by using such a toner in an image-forming apparatus, for example, equipped with a cleaning blade for cleaning the photosensitive body.

### BACKGROUND OF THE INVENTION

1. Field of the Invention

The present invention relates to a toner for image formation, a method of producing toner particles, an image-forming apparatus and an image-forming process.

2. Description of the Related Art

Toners in combination of toner particles containing components such as binder resin, colorant, wax and charge-controlling agent and external additives such as silica particles have been known as the toners for use in an image-forming apparatus such as electrophotography.

As described in Japanese Unexamined Patent Publication No. hei 5-100484, the methods of forming such toner particles include a suspension polymerization method of allowing suspension-polymerizing a binder resin-forming monomer in the presence of colorant, wax, charge-controlling agent, and others, a melt extrusion method of melt-extruding a binder resin with colorant, wax, charge-controlling agent, and the like and then pulverizing the resulting resin composition, and the like.

As described in Japanese unexamined patent publication 2004-138691, toner particles, the principal component of a toner, are preferably higher in circularity (sphericality), for improvement in transfer efficiency during image formation and also in image quality.

However, when a toner mainly containing more spherical toner particles is used in an image-forming apparatus having a photosensitive body and a cleaning blade placed in contact therewith for removing residual toner on the photosensitive body after transfer by scraping off the residual toner, there existed a problem that a part of the residual toner passed across the clearance between the cleaning blade and the photosensitive body when the residual toner was removed with the cleaning blade. The leakage of the part of the residual toner across the clearance caused a problem of lowering cleaning efficiency of a surface of the photosensitive body. Insufficient cleaning resulted in image staining, for example, by generation of vertical lines in the image formed.

To solve the problem above, relatively larger inorganic particles are often added to the toner particle as an external additive (for example, Japanese Unexamined Patent Publication Nos. hei 5-346682, hei 6-313980, and 2000-81723, and others). However, use of the toner containing relatively larger inorganic particles externally added lead to improvement in initial cleaning efficiency, but caused a problem of gradual deterioration of the cleaning efficiency when used continuously for an extended period of time. It is because the inorganic particles are gradually released from the surface of the toner particles. In addition, when inorganic particles were added to toner particles externally, the inorganic particles occasionally absorbed heat during fixation, leading to deterioration in the fixing efficiency of the toner, for example, on recording paper.

Also known are toners containing toner particles and other resin fine particles (for example, Japanese Unexamined Patent Publication No. 2004-138691).

However, when the binder resin contained in the toner particles and the resin component in the other resin fine particles added are different from each other in composition, there was a concern about deterioration in the fixing efficiency of the toner and also about the additional production cost for the resin fine particles.

Toner particles obtained by suspension polymerization method are more uniform in particle diameter and narrower in particle size distribution than toner particles obtained by melt extrusion method, and thus, advantageous. However, production of toner particles by the suspension polymerization method is often accompanied with generation of polymerization microparticles. The polymerization microparticles are seemingly formed by emulsion polymerization of part of the monomer released into the aqueous phase during the suspension polymerization. Generation of the polymerization microparticles makes filtration of the toner particles after suspension polymerization difficult and leads to deterioration in the flowability of the toner obtained, consequently causing a problem such as deterioration in refilling efficiency and electrostatic property when used as a developer. Thus, in the conventional suspension polymerization methods, a method such as addition of a polymerization inhibitor is taken for preventing generation of the polymerization microparticles by emulsion polymerization (for example, Japanese Unexamined Patent Publication No. hei 5-100484).

### SUMMARY OF THE INVENTION

An object of the present invention is to provide a toner for use in an image-forming apparatus having a photosensitive body that is superior in long-term cleaning efficiency of a surface of the photosensitive body and toner fixing efficiency.

An aspect of the present invention is a toner containing toner particles, comprising microparticle-deposited toner particles carrying polymerization microparticles having a particle diameter of 100 to 2,000 nm deposited on the surface of primary polymerization particles having a particle diameter of 3 to 12 μm in an amount of 80 pieces or more with respect to 100 pieces of the toner particles.

The object, characteristics, aspects, and advantages of the present invention will become more evident in the following detailed description and the drawings attached.

### BRIEF DESCRIPTION OF THE DRAWINGS

FIG. 1 is a schematic view illustrating the microparticle-deposited toner particle according to the invention carrying polymerization microparticles deposited on the surface of primary polymerization particles.

FIG. 2 is a schematic view illustrating the configuration of an image-forming apparatus.

### DETAILED DESCRIPTION OF THE PREFERRED EMBODIMENTS

The invention is now described, by way of example, with reference to the accompanying drawings.

The toner in an embodiment of the present invention will be described below.

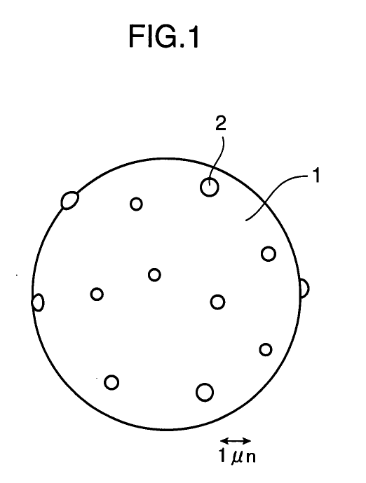

The toner in the present embodiment is a toner containing toner particles, comprising toner particles containing primary polymerization particles 1 and polymerization microparticles 2 having a particle diameter of 100 nm to 2,000 nm deposited on the surface thereof (hereinafter, referred to microparticle-deposited toner particles), as shown in the schematic view of FIG. 1, in an amount of 80 pieces or more with respect 100 pieces of the toner particles.

As will be described below in detail, the microparticle-deposited toner particles are produced, for example, by allowing deposition of polymerization microparticles, a by-product of suspension polymerization, on the surface of the primary polymerization particles, a main-product of the suspension polymerization.

The toner in the present embodiment contains the microparticle-deposited toner particles carrying the polymerization microparticles having a particle diameter of 100 to 2,000 nm deposited on the surface of the primary polymerization particles of 3 to 12 μm in size.

Use of the toner above in an image-forming apparatus leads to improvement in the cleaning efficiency of its photosensitive body. It is because the toner remaining on the photosensitive body surface after transfer does not pass easily across a clearance between a cleaning blade and the photosensitive body during removal thereof with the cleaning blade, due to the resistance of the microparticle-deposited toner particles caused by the surface irregularity.

The polymerization microparticles are released less easily, because they are deposited tightly on the surface of the primary polymerization particles in the microparticle-deposited toner particles. It is thus possible to obtain high cleaning efficiency, even when the image-forming apparatus is operated continuously for an extended period of time. On the other hand, when a toner containing toner particles carrying no polymerization microparticles deposited tightly on the surface of primary polymerization particles but carrying the microparticles without deposition, for example only by aggregation, on the surface thereof is used, it is not possible to keep sufficiently high cleaning efficiency, in particular during continuous operation for an extended period of time, because of release of the polymerization microparticles.

The microparticle-deposited toner particles are particles containing the primary polymerization particles and the polymerization microparticles obtained by suspension polymerization, and preferably prepared by depositing the polymerization microparticles obtained as a by-product of the suspension polymerization on the surface of the primary polymerization particles obtained as a main product. In such a case, the primary polymerization particles and the polymerization microparticles have compositions similar to each other, and thus, there is no concern about the adverse effect on the fixing efficiency of the toner by deposition of the polymerization microparticles. It is also possible to obtain the microparticle-deposited toner particles more easily and economically by the production method above, compared to a method, for example, of producing the toner particles by depositing polymerization microparticles prepared in other step on the surface of primary polymerization particles obtained by suspension polymerization.

The volume-average particle diameter of the primary polymerization particles in the microparticle-deposited toner particles in the present embodiment is preferably 5 to 10 μm, from the point of the image quality obtained in the image-forming apparatus. Use of microparticle-deposited toner particles containing the primary polymerization particles having a circularity of 0.970 or more, as determined with a flow particle image analyzer, is preferable, because it is possible to obtain a toner superior in transfer efficiency during image formation and also in image quality.

On the other hand, the particle diameter of the polymerization microparticles deposited on the surface of the primary polymerization particles in the present embodiment is 100 to 2,000 nm. The number-average particle diameter of the polymerization microparticles deposited on the surface of the primary polymerization particles is preferably 200 to 800 nm, more preferably 300 to 600 nm. A number-average particle diameter of the polymerization microparticles at more than 800 nm may lead to deterioration in the flowability of the toner. Alternatively, a number-average particle diameter of the polymerization microparticles at less than 200 nm may lead to insufficient cleaning efficiency.

The toner in the present embodiment is a toner containing toner particles, including microparticle-deposited toner particles carrying polymerization microparticles having a particle diameter of 100 to 2,000 nm deposited on the surface of primary polymerization particles having a particle diameter of 3 to 12 μm in an amount of 80 pieces or more with respect to 100 pieces of the toner particles. In other words, it is a toner in which 80% or more by number of the total toner particles are the microparticle-deposited toner particles. A number of the microparticle-deposited toner particles of 80 pieces or less with respect 100 pieces of the toner particles leads to insufficient improvement in cleaning efficiency.

The number of the polymerization microparticles per primary polymerization particle in the microparticle-deposited toner particle is not particularly limited, and at least one polymerization microparticle is deposited thereon.

Presence of the polymerization microparticles on the surface of the primary polymerization particles, the diameter of the polymerization microparticles deposited on the primary polymerization particles, and the numerical ratio of the microparticle-deposited toner particles in the total toner particles are determined by the following methods.

Methanol is first added to a toner in an amount sufficient for complete dispersion, to give a dispersion. The dispersion obtained is ultrasonicated for sufficient dissociation of aggregated toner particles. Filtration of the dispersion containing deaggregated toner particles gives separated toner particles. The toner particle separated on filter is dried under reduced pressure, to give a sample. Presence of the polymerization microparticles on the surface of the primary polymerization particles in the sample obtained is evaluated under a scanning electron microscope (SEM). If there exist polymerization microparticles remaining on the surface of the primary polymerization particles, the polymerization microparticles may be judged that they are deposited on the primary polymerization particles. The numerical ratio of the microparticle-deposited toner particles in the total toner particles (number %) is determined by counting the number of microparticle-deposited toner particles in randomly selected 100 pieces of toner particles. It is possible in this manner to determine the number of the microparticle-deposited toner particles in the total toner particles and the diameter of the polymerization microparticles in the microparticle-deposited toner particles.

The toner in the present embodiment is prepared, for example, by the following manner.

A polymerization composition is first prepared by mixing a radical polymerizable monomer for forming a binder resin, a crosslinking agent, a polymerization initiator, and a colorant, and as needed other components such as charge-controlling agents, waxes, and others in a ball mill.

Examples of the radical polymerizable monomers include styrene and the derivatives thereof such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, and p-n-dodecylstyrene; ethylenic unsaturated monoolefins such as ethylene, propylene, butylene, and isobutylene; halogenated vinyl compounds such as vinyl chloride, vinylidene chloride, vinyl bromide, and vinyl fluoride; vinyl esters such as vinyl acetate, vinyl propionate, and vinyl benzoate: α-methylene fatty monocarboxylic esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylic esters such as methyl acrylate, ethyl acrylate, propyl acrylate, n-butyl acrylate, isobutyl acrylate, n-octyl acrylate, dodecyl acrylate, 2-ethylhexyl acrylate, stearyl acrylate, 2-chloroethyl acrylate, and phenyl acrylate; vinyl ethers such as vinylmethylether, vinylethylether, and vinylisobutylether; vinyl ketones such as vinylmethylketone, vinylhexylketone, and methyl isopropenylketone; N-vinyl compounds such as N-vinylpyrrole, N-vinylcarbazole, N-vinylindole, and N-vinylpyrrolidone; vinylnaphthalenes; acrylic or methacrylic derivatives such as acrylonitrile, methacryl nitrile, and acrylamide; and the like. These compounds may be used alone or in combination or two or more.

Examples of the crosslinking agents include divinylbenzene, divinylnaphthalene, divinylether, divinylsulfone, diethylene glycol dimethacrylate, triethylene glycol dimethacrylate, ethylene glycol dimethacrylate, polyethylene glycol dimethacrylate, diethylene glycol diacrylate, triethylene glycol diacrylate, 1,3-butylene glycol dimethacrylate, 1,6-hexane glycol dimethacrylate, neopentylglycol dimethacrylate, dipropylene glycol dimethacrylate, polypropylene glycol dimethacrylate, 2,2-bis(4-methacryloxydiethoxyphenyl)propane, 2,2-bis (4-acryloxydiethoxyphenyl)propane, trimethylolpropane trimethacrylate, trimethylolpropane triacrylate, tetramethylolmethane tetraacrylate, dibromoneopentylglycol dimethacrylate, diallyl phthalate, and the like. These compounds may be used alone or in combination of two or more. The amount of the crosslinking agent blended is preferably 0.5 to 1.5 parts by mass with respect to 100 parts by mass of the radical polymerizable monomer. When the blending rate of the crosslinking agent is in the range above, it is possible to obtain a toner superior in blocking resistance, durability and fixing efficiency and also resistant to offsetting phenomenon.

The polymerization initiator may be any one of known compounds including azobisisobutylonitrile, benzoyl peroxide, methylethylketone peroxide, isopropyl peroxide, isopropyl peroxycarbonate, cumene hydroperoxide, 2,4-dichlorobenzoyl peroxide, lauroyl peroxide, 2,2-azobis(2,4-dimethylvaleronitrile), and the like. The amount of the polymerization initiator blended is preferably 0.1 to 10 parts by mass with respect to 100 parts by mass of the radical polymerizable monomer.

The colorant for use may be any one of known pigments or dyes. Examples of the pigments include chrome yellow, cadmium yellow, mineral Fast Yellow, navel yellow, naphthol yellow S, hanza yellow, permanent yellow NCG, Tartlane dilake, orange chrome, molybdenum orange, permanent orange GTR, pyrazolone orange, benzidine orange G, cadmium red, Permanent Red 4R, Watchung Red calcium salt, Euciso lake, Brilliant Carmine 3B, manganese purple, Fast Violet B, methyl violet lake, iron blue, cobalt blue, alkali blue lake, Victoria blue lake, phthalocyanine blue, Fast Sky Blue, indanthrene blue BC, chromium green, chromium oxide, pigment green B, malachite green lake, final yellow green G, carbon black, acetylene black, lamp black and the like. Examples of the dyes include C.I. Direct Red 1, C.I. Direct Red 4, C.I. Acid Red 1, C.I. Basic Red 1, C.I. Mordant Red, C.I. Direct Blue 1, C.I. Acid Blue 1, C.I. Acid Blue 2, C.I. Acid Blue 9, C.I. Acid Blue 15, C.I. Basic Blue 3, C.I. Basic Blue, C.I. Mordant Blue 7, C.I. Direct Green 6, C.I. Basic Green 4, C.I. Basic Green 6 and the like.

The amount of the colorants blended is preferably 5 to 15 parts by mass with respect to 100 parts by mass of the radical polymerizable monomer.

Examples of the charge-controlling agents include metal-containing dyes, nigrosine dyes, quaternary ammonium compounds, polar group-containing resins, and the like.

Examples of the waxes include various waxes such as fatty acid polyvalent alcohol esters, fatty acid higher alcohol esters, alkylene bisfatty acid amide compounds, and natural waxes; low-molecular weight olefinic resins having a number-average molecular weight in the range of 1,000 to 10,000, preferably 2,000 to 6,000, such as polypropylene, polyethylene, and propylene-ethylene copolymers; and the like. Among these waxes, low-molecular weight polypropylene is preferable.

Apparently during suspension polymerization, polymerization microparticles are produced additionally by emulsion polymerization of part of the monomers in the aqueous phase. Thus, it is preferable to add a water-soluble polymerization inhibitor to the polymerization composition in a suitable amount in order to control the amount of the polymerization microparticles, the by-product of the suspension polymerization. An excessive polymerization inhibitor blending rate leads to decline of the polymerization microparticle generation, and thus, the amount of the polymerization inhibitor blended is preferably 0.01 parts or less by mass with respect to 100 parts by mass of the radical polymerizable monomer.

The polymerization inhibitor for use is preferably soluble in water, and examples thereof include metal salts such as cupric chloride, sodium nitrite and potassium nitrite, hydroquinone, and the like. These compounds may be used alone or in combination of two or more combination.

A magnetic powder may be added additionally to the polymerization composition for preparation of a magnetic toner. Typical examples of the magnetic powders include ferromagnetic metals or alloys such as iron, cobalt, and nickel, compounds containing the element (such as ferrite and magnetite), alloys containing no ferromagnetic element but becoming ferromagnetic by suitable heat treatment; chromium dioxide; and the like. The amount of the magnetic powder blended is preferably 20 to 100 parts by mass with respect to 100 parts by mass of the radical polymerizable monomer.

Then, a dispersion is prepared by adding the above-obtained polymerization composition in an aqueous medium such as water, adding a suspension stabilizer thereto, and agitating the mixture, for example, in a stirrer, homomixer, or homogenizer, allowing suspension for forming particles.

The amount of the aqueous medium is preferably approximately 200 to 800 parts by mass with respect to 100 parts by mass of the polymerization composition. The suspension for forming particles is performed by agitating the mixture under a condition giving droplets having a desirable particle diameter, for example 3 to 15 μm, normally at 20 to 50° C. for 10 to 30 minutes.

The suspension stabilizer for use is an organic or inorganic dispersant. Typical examples of the organic dispersants include gelatin, starch, water-soluble cellulose derivatives such as carboxymethylcellulose, polyvinylalcohol, anionic, nonionic, cationic, or amphoteric surfactants, and the like. Typical examples of the inorganic dispersants include calcium tertiary phosphate, calcium carbonate, magnesium phosphate, magnesium carbonate, silica, alumina, talc, various clays such as bentonite, scarcely-soluble inorganic fine particles such as of diatomaceous soil, and the like. These compounds may be used alone or in combination of two or more.

The amount of the suspension stabilizer used is preferably 0.1 to 10 parts by mass with respect to 100 parts by mass of the aqueous medium. In such a range, it is possible to obtain the stable suspended-particle dispersion and prevent deterioration in the moisture resistance of the toner caused by residual of the suspension stabilizer on the surface of the toner particles.

When the dispersion is kept agitated under an inactive gas atmosphere at around 50 to 100° C. for 3 to 12 hours, primary polymerization particles are generated as the main product and simultaneously, polymerization microparticles as the by-product (hereinafter called “polymerization step”). The polymerization microparticles seem to be generated by emulsion polymerization of part of the monomer leaching from the suspension particles into the aqueous phase.

Filtration of the dispersion obtained after the polymerization step and washing and drying of the filtrate give crude toner particles containing the primary polymerization particles and the polymerization microparticles. The suspension stabilizer in the dispersion may be eliminated by washing the dispersion before filtration.

The volume-average particle diameter of the primary polymerization particles thus obtained is preferably 5 to 10 μm from the point of the image quality obtained in an image-forming apparatus. The polymerization microparticles in the crude toner particles thus obtained are not deposited tightly on the surface of the primary polymerization particles. As for the ratio by mass of the primary polymerization particles to the polymerization microparticles in the crude toner particles, the ratio of the polymerization microparticles is preferably approximately 0.1 to 10 parts by mass with respect to 100 parts by mass of the primary polymerization particles.

Then, the polymerization microparticles are deposited tightly on the surface of the primary polymerization particles (hereinafter called “fixation step”), while the crude toner particles obtained are agitated at high speed as heated at a predetermined temperature, for example, at around 30 to 50° C.

The polymerization microparticles having a lower heat capacity soften and melt preferentially and deposit on the surface of the primary polymerization particles, when the crude toner particles are heated in the fixation step. The temperature in this step is the temperature of the crude toner particles stored in the agitating machine. In such a fixation step, it is possible to deposit the polymerization microparticles on the surface of the primary polymerization particles sufficiently without affecting the favorable toner characteristics.

The toner particles are preferably agitated under strong shearing force in the fixation step, specifically at 1,000 to 5,000 rpm for 1 to 10 minutes in a Henschel mixer.

Instead of the method above, the toner particles obtained by filtration and washing of the dispersion after the polymerization step may be dried in a stirrer such as Henschel mixer under the condition described above, for performing simultaneous drying and fixation in the fixation step.

It is possible to obtain toner particles containing the microparticle-deposited toner particles, by such processing in the polymerization step and the fixation step.

The toner particles obtained are used as a toner as they are or after addition of external additives as needed.

Typical examples of the external additives include inorganic oxides such as silica, titanium oxide, and alumina; metal soaps such as calcium stearate; and the like. The amount of the external additive added is preferably approximately 0.3 to 4 parts by mass with respect to 100 parts by mass of the toner particles.

The external additive may be added to the stirrer in the fixation step described above, simultaneously with the fixation to the toner particles, but heating in the fixation step causes softening of the toner particles and embedding of the external additives, possibly prohibiting part of the functions of the external additives. Thus, the external additive is preferably added to the toner particle and mixed therewith, for example, in a Henschel mixer after the fixation step.

The toner obtained may be used as a two-component developer in combination with a carrier or as a one-component developer. Any one of known materials such as magnetic substance particles, or magnetic resin particles containing a magnetic substance in a binder resin may be used as the carrier.

The toner containing the toner particles above is used favorably in a commonly image-forming apparatus equipped with a toner-cleaning device in a electrophotographic process, in particular in an image-forming apparatus equipped with a cleaning blade for cleaning a photosensitive body.

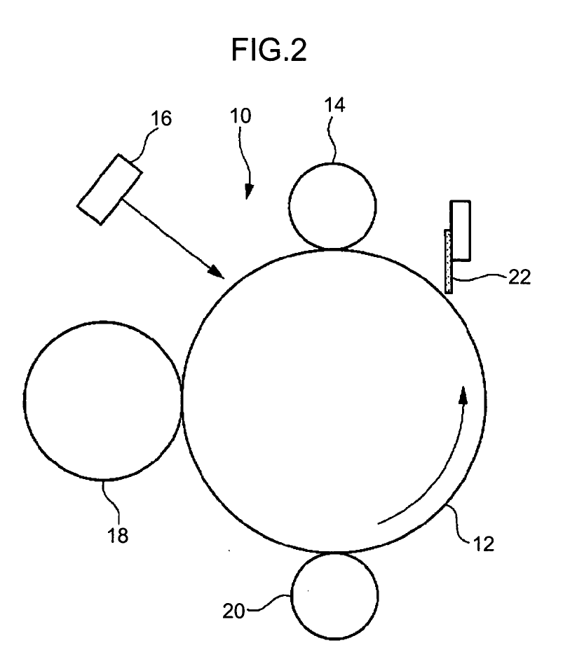

An example of the image-forming apparatus will be described with reference to the schematic view of FIG. 2.

In the image-forming apparatus 10 shown in FIG. 2, a photosensitive body 12 revolving in the arrow direction is electrostatically charged by an electrification device 14, and an electrostatic latent image is formed on the surface of the photosensitive body 12 by light irradiation. A toner is supplied by a developing device 18 onto the surface of the photosensitive body 12 carrying the formed electrostatic latent image, developing the electrostatic latent with the toner. The toner image formed is then transferred onto an image-receiving medium such as paper not shown in the Figure by a transfer device 20. After transfer, the toner remaining on the surface of the photosensitive body 12 is scraped off with a cleaning blade 22 placed in contact with the photosensitive body 12. Then, use of the toner according to the present invention, which makes the toner remaining on the surface of photosensitive body 12 resistant to pass across the clearance between the cleaning blade 22 and the photosensitive body 12, improves the cleaning efficiency of the photosensitive body 12. It is also possible to retain the high cleaning efficiency for an extended period of time and thus, to form high-quality images reliably for an extended period of time.

### EXAMPLES

Hereinafter, the toner according to the present invention will be described more specifically with reference to Examples shown below, but it should be understood that the invention is not limited thereto.

### Example 1

First, the method of producing the toner will be described.

### (Polymerization Step)

A mixture solution containing 80 parts of styrene (parts by mass, the same shall apply hereinafter), 20 parts of 2-ethylhexyl methacrylate, 5 parts of carbon black (MA-77, manufactured by Mitsubishi Chemical Corp.), 3 parts of a low-molecular weight polypropylene (Sanwax LEL-250, manufactured by Sanyo Chemical Industries), 2 parts of a charge-controlling agent (Bontron S-34, manufactured by Orient Chemical Industries), and 1 part of divinylbenzene (crosslinking agent) was agitated thoroughly in a ball mill; 3 parts of a polymerization initiator 2,2-azobis(2,4-dimethylvaleronitrile) was added additionally, to give a polymerization composition.

400 Parts of ion-exchange water, 5 parts of a suspension stabilizer calcium tertiary phosphate, and 0.1 part of sodium dodecylbenzenesulfonate were added to the polymerization composition obtained; the mixture was agitated in a TK homomixer (manufactured by Tokushu Kika Kogyo) at a rotational frequency of 6,000 rpm for 45 minutes, to give a dispersion.

The dispersion obtained was subjected to suspension polymerization reaction while stirred with an agitating blade at 100 rpm under a nitrogen environment at 70° C. for 10 hours. Calcium tertiary phosphate in the suspension polymerization liquid obtained was removed by acid washing.

The suspension polymerization liquid after washing was filtered; the particles separated were dried, to give crude toner particles containing a main-product, primary polymerization particles, and a by-product, polymerization microparticles. The volume-average particle diameter of the primary polymerization particles obtained was 7.8 μm, and the circularity thereof, 0.974. The volume-average particle diameter was determined by using Multisizer III (manufactured by Coulter Counter), and the circularity by using a flow particle image analyzer (FPIA-2100, manufactured by Sysmex).

### (Fixation Step)

500 g of the crude toner particles obtained were agitated in a Henschel mixer (FM-10C, manufactured by Mitsui Mining Com.) at 45° C. and 3,500 rpm for 10 minutes, allowing deposition of the polymerization microparticles on the surface of the primary polymerization particles, to give toner particles.

### (External Addition)

0.8 part of silica having a particle diameter of 12 nm (R974, manufactured by Nippon Aerosil) was added as an external additive to 100 parts of the toner particles obtained. The toner particles and silica were agitated in a Henschel mixer (FM-10C, manufactured by Mitsui Mining Com.) at 20° C. and 2,000 rpm for 2 minutes, to give a toner.

### (Confirmation of Deposition of Polymerization Microparticles on Primary Polymerization Particles)

1 g of the toner obtained was dispersed in 20 g of methanol, and the mixture was ultrasonicated for 1 minute, to give a dispersion. The dispersion obtained was filtered, and the toner particles separated were dried under reduced pressure.

The toner particles dried under reduced pressure were analyzed under a scanning electron microscope (SEM). Observation of 100 toner particles chosen randomly from the toner particles in the SEM image showed presence of microparticle-deposited toner particles carrying the polymerization microparticles having a particle diameter of 100 nm or more deposited on the surface of the primary polymerization particles of 3 to 12 μm in size.

The number of the microparticle-deposited toner particles carrying the polymerization microparticles having a particle diameter of 100 nm or more deposited on the surface of the primary polymerization particles of 3 to 12 μm in size was determined, and the rate by number of the microparticle-deposited toner particles in the total toner particles was determined. The number-average particle diameter of the polymerization microparticles deposited on the primary polymerization particles was also determined. As a result, the polymerization microparticles having a particle diameter of 100 nm or more were deposited on the surface of all 100 toner particles observed. The number-average particle diameter of the deposited polymerization microparticles was 500 nm.

### <Evaluation of Toner>

The initial cleaning efficiency, long-term cleaning efficiency, and fixing efficiency of the toner obtained were evaluated by using the following copying machine equipped with an image-forming apparatus as a test machine by the following method.

Test Machine

Machine: Electrification system modified machine of Canon LBP-2410 (manufactured by Canon. Co. LTD)
Linear velocity: 117 mm/sec

### Drum: negatively charged OPC

### Development: nonmagnetic mono-component development

Cleaning blade (polyurethane rubber): rubber thickness: 2 mm, projection: 7.5 mm, hardness: 70°, linear pressure: 40 gf/cm, pressure contact angle: 33.50

Initial Cleaning Efficiency

The toner obtained was placed in the test machine; four band-shaped images respectively 10 cm in length and 2 cm in width aligned in parallel were printed continuously; and presence of cleaning defect was evaluated by visual observation according to the following criteria:

### Excellent: No staining or vertical lines in the image after continuous printing on 50 sheets.

### Good: Some staining and vertical lines in the image during continuous printing on 10 to less than 50 sheets.

### Inferior: Staining and vertical lines in the image in continuous printing on less than 10 sheets.

Long-Term Cleaning Efficiency

The toner obtained was placed in the test machine; a document with a black ratio of 5% (5%-duty document) was printed on 1,000 sheets, and then four band-shaped images respectively 10 cm in length and 2 cm in width aligned in parallel were printed continuously on ten sheets; and presence of cleaning defect was evaluated by visual observation according to the following standard:

### Excellent: No staining or vertical lines at all.

### Good: Slight staining or vertical lines observed in non-image-forming region.

### Inferior: Some staining and vertical lines in image.

Fixing Efficiency Test (Tape Peel Test)

The toner obtained was placed in the test machine, and a black image (solid image) of 30 mm×30 mm in size was printed on the edge of paper. The cover for the test machine was opened during output, taking the unfixed image paper out, and the toner on the unfixed image paper was collected with a suctioning device. The amount of the toner remaining on the paper was calculated from the weight of the toner thus collected. The development bias was so adjusted that the amount of the toner on paper becomes 0.4 to 0.5 (mg/cm²). After adjustment, the black image developed was printed. A mending tape (equivalent to No. 810-3-12, available from Sumitomo 3M) was bonded weakly to the printed black image, and the tape was scraped reciprocally five times under a load of 2.30 gf/cm². The tape was then peeled off gradually at an angle of approximately 90 degrees, and the black image after tape separation was observed and evaluated according to the following evaluation criteria.

### Good: No toner separation in black image.

### Inferior: Partial toner separation in black image and exposure of the paper below.

### Results are summarized in Table 1.

### Example 2

A toner was prepared and evaluated in a similar manner to Example 1, except that 0.01 part of cupric chloride (polymerization inhibitor) was added in preparation of the polymerization composition in the polymerization step. The volume-average particle diameter of the primary polymerization particles having a diameter of 3 to 12 μm obtained was 7.8 μm, and the circularity, 0.973. It was also confirmed that the polymerization microparticles having a particle diameter of 100 nm or more were deposited on the surface of the toner particles in an amount of 80 number % with respect to the total toner particles. The number-average particle diameter of the deposited polymerization microparticles was 300 nm. Evaluation results are summarized in Table 1.

### Example 3

A toner was prepared and evaluated in a similar manner to Example 1, except that 0.01 part of hydroquinone (polymerization inhibitor) was added in preparation of the polymerization composition in the polymerization step. The volume-average particle diameter of the primary polymerization particles having a diameter of 3 to 12 μm obtained was 7.5 μm, and the circularity, 0.97. It was also confirmed that polymerization microparticles having a particle diameter of 100 nm or more were deposited on the surface of all toner particles. The number-average particle diameter of the deposited polymerization microparticles was 200 nm. Evaluation results are summarized in Table 1.

### Comparative Example 1

A toner was prepared and evaluated in a similar manner to Example 1, except that no fixation treatment was performed after the polymerization step. As a result, there was no polymerization microparticle having a particle diameter of 100 nm or more deposited on the surface of the toner particles. Evaluation results are summarized in Table 1.

### Comparative Example 2

A toner was prepared and evaluated in a similar manner to Example 1, except that 0.02 part of cupric chloride (polymerization inhibitor) was added in preparation of the polymerization composition in the polymerization step. The volume-average particle diameter of the primary polymerization particles obtained was 7.5 μm, and the circularity, 0.975. It was also confirmed that polymerization microparticles having a particle diameter of 100 nm or more were deposited on the surface of the toner particles in an amount of 70 number % with respect to the total toner particles. The number-average particle diameter of the deposited polymerization microparticles was 200 nm. Evaluation results are summarized in Table 1.

### Comparative Example 3

A toner was prepared and evaluated in a similar manner to Example 1, except that 0.1 part of cupric chloride (polymerization inhibitor) was added in preparation of the polymerization composition in the polymerization step and no fixation treatment was performed. Addition of 0.1 part of the polymerization inhibitor resulted in almost no generation of polymerization microparticles. The volume-average particle diameter of the primary polymerization particles obtained was 7.2 μm, and the circularity, 0.978. As a result, there was no polymerization microparticle having a particle diameter of 100 nm or more were deposited on the surface of the toner particles. Evaluation results are summarized in Table 1.

### Comparative Example 4

A toner was prepared and evaluated in a similar manner to Comparative Example 3, except that 1.2 parts of silica having a number-average primary particle diameter of 100 nm (Seahostar KE-PLO, manufactured by Nippon Shokubai) was added in the external addition treatment. There was no polymerization microparticle having a particle diameter of 100 nm or more deposited on the surface of all toner particles. Evaluation results are summarized in Table 1.

### Comparative Example 5

A toner was prepared and evaluated in a similar manner to Comparative Example 3, except that 1.2 parts of melamine resin particles having a number-average primary particle diameter of 200 nm (Epostar S, manufactured by Japan catalyst) was added in the external addition treatment. There was no polymerization microparticle having a particle diameter of 100 nm or more were deposited on the surface of all toner particles. Evaluation results are summarized in Table 1.

### Comparative Example 6

A toner was prepared and evaluated in a similar manner to Example 1, except that 0.02 part of hydroquinone (polymerization inhibitor) was added in preparation of the polymerization composition in the polymerization step. There were no toner particles in which polymerization microparticles having a particle diameter of 100 nm or more were deposited on the surface of primary polymerization particles, but there were some toner particles carrying deposited polymerization microparticles having a particle diameter of less than 100 nm. Evaluation results are summarized in Table 1.

TABLE 1

| | | | | Properties of toner particle | | Evaluation result | | |
|---|---|---|---|---|---|---|---|---|
| | Characteristics | | | Rate of | Number-average | | Long- | |
| | in production | | | microparticle-deposited | particle diameter of | Initial | term | Fixing |
| Example | Polymerization | Fixation | | toner particles | polymerization | cleaning | cleaning | efficiency |
| No. | inhibitor | step | Others | (number-based %) | microparticles (nm) | efficiency | efficiency | of toner |
| 1 | None | Yes | — | 100 | 500 | Excellent | Excellent | Good |
| 2 | Cupric chloride 0.01 | Yes | — | 80 | 300 | Good | Good | Good |
| | part | | | | | | | |
| 3 | Hydroquinone 0.01 | Yes | — | 100 | 200 | Good | Good | Good |
| | part | | | | | | | |
| Comparative | None | No | — | 0 | — | Good | Inferior | Good |
| Example 1 | | | | | | | | |
| Comparative | Cupric chloride 0.02 | Yes | — | 70 | 200 | Inferior | Inferior | Good |
| Example 2 | part | | | | | | | |
| Comparative | Cupric chloride 0.1 | No | — | 0 | — | Inferior | Inferior | Good |
| Example 3 | part | | | | | | | |
| Comparative | Cupric chloride 0.1 | No | 100 nm silica | 0 | — | Good | Inferior | Inferior |
| Example 4 | part | | externally added | | | | | |
| Comparative | Cupric chloride 0.1 | No | 200 nm melamin | 0 | — | Good | Inferior | Inferior |
| Example 5 | part | | resin particles | | | | | |
| | | | externally added | | | | | |
| Comparative | Hydroquinone 0.02 | Yes | — | 0 | less than 100 | Inferior | Inferior | Good |
| Example 6 | part | | | | | | | |

As apparent from Table 1, the toner in each example, which has microparticle-deposited toner particles containing polymerization microparticles having a number-average particle diameter of 100 nm or more deposited on the surface of the main product of suspension polymerization, i.e., primary polymerization particles of 3 to 12 μm in particle diameter, in an amount of 80 pieces with respect to 100 pieces of the toner particles, was superior all in initial cleaning efficiency, long-term cleaning efficiency, and fixing efficiency of the toner.

On the other hand, the toner of Comparative Example 1 obtained without the fixation treatment was favorable in initial cleaning efficiency, but the long-term cleaning efficiency declined over time. It seems that, although the initial cleaning efficiency was favorable for some time because the polymerization microparticles aggregated on the surface of primary polymerization particles, the polymerization microparticles are gradually released because of absence of the fixation step.

The toner of Comparative Example 2 prepared with a greater amount of a polymerization inhibitor contained a smaller number of microparticle-deposited toner particles carrying polymerization microparticles deposited on the surface and thus, was lower in improvement of cleaning efficiency.

The toner of Comparative Example 3 prepared with an even greater amount of a polymerization inhibitor contained no microparticle-deposited toner particles carrying polymerization microparticles deposited on the surface, and thus, there was no improvement in cleaning efficiency.

The toner of Comparative Example 4, to which silica having a number-average particle diameter of 100 nm was added externally replacing the polymerization microparticles, was improved in initial cleaning efficiency, but lower in long-term cleaning efficiency and fixing efficiency of the toner.

The toner of Comparative Example 5, to which melamine resin particles having a number-average particle diameter of 200 nm were added externally replacing the polymerization microparticles, was superior in initial cleaning efficiency, but its long-term cleaning efficiency gradually declined, possibly because of gradual release of the melamine resin particles from the toner particle. The fixing efficiency of the toner was also lower, because the primary polymerization particles and the externally added resin particles were different from each other in composition.

In the toner of Comparative Example 6, there were observed toner particles carrying polymerization microparticles having a particle diameter of less than 100 nm deposited on the surface of primary polymerization particles of 3 to 12 μm in particle diameter, but there was no improvement in cleaning efficiency.

As described above, an aspect of the present invention is a toner containing toner particles, comprising microparticle-deposited toner particles carrying polymerization microparticles having a particle diameter of 100 to 2,000 nm deposited on the surface of primary polymerization particles having a particle diameter of 3 to 12 μm in an amount of 80 pieces or more with respect to 100 pieces of the toner particles. It is possible to obtain favorable long-term cleaning efficiency of a photosensitive body by using such a toner in an image-forming apparatus, for example, equipped with a cleaning blade for cleaning the photosensitive body.

A volume-average particle diameter of the primary polymerization particles at 5 to 10 μm is favorable from the point of the image quality obtained in image-forming apparatus.

The number-average particle diameter of the polymerization microparticles deposited on the surface of the primary polymerization particles is preferably 200 to 800 nm, because the cleaning effect is particularly higher.

In addition, the primary polymerization particles and the polymerization microparticles preferably contain resin components substantially similar in composition, because deposition of the polymerization microparticles does not affect the toner fixing efficiency.

Further, the circularity of the primary polymerization particles is preferably 0.970 or more, because it is possible to obtain a toner having favorable transfer efficiency during image formation and giving a high-quality image.

The primary polymerization particles and the polymerization microparticles are preferably prepared by suspension polymerization, because the production is easier.

The polymerization microparticles are preferably particles prepared as a by-product of the suspension polymerization, because the production is easier and cost-effective.

Another aspect of the present invention is a method of producing toner particles by heating and agitating a particle mixture containing primary polymerization particles having a volume-average particle diameter of 5 to 10 μm derived from the main product of suspension polymerization and polymerization microparticles having a particle diameter of 100 to 2,000 nm derived from the by-product of the suspension polymerization at a predetermined temperature, allowing deposition of the polymerization microparticles on the surface of the primary polymerization particles. The production method is favorable, because it is possible to obtain easily and cost-effectively toner particles containing microparticle-deposited toner particles carrying the polymerization microparticles having a particle diameter of 100 to 2,000 nm deposited on the surface of the primary polymerization particles having a particle diameter of 3 to 12 μm in an amount of 80 pieces with respect to 100 pieces of the toner particles.

The predetermined temperature is preferably 30 to 50° C., for easier deposition of the polymerization microparticles on the surface of the primary polymerization particle while deposition of the primary polymerization particles is prevented.

Another aspect of the present invention is an image-forming apparatus, comprising a photosensitive body where an electrostatic latent image in an particular image is formed by photoirradiation, a developing device of forming a toner image by supplying a toner onto the surface of the photosensitive body carrying the electrostatic latent image formed, a transfer device of transferring the toner image onto an image-receiving medium, and a cleaning device of removing the residual toner by scraping off the toner remaining on the photosensitive body after transfer with a cleaning blade placed in contact with the photosensitive body, wherein the toner described above is used as the toner. Such an image-forming apparatus is superior in the long-term cleaning efficiency of photosensitive body and the fixing efficiency of toner.

Yet another aspect of the present invention is an image-forming process, comprising an electrostatic latent image-forming step of forming an electrostatic latent image in a particular image on the surface of a photosensitive body by photoirradiation, a developing step of forming a toner image by supplying a toner onto the surface of the photosensitive body carrying the electrostatic latent image formed, a transferring step of transferring the toner image onto an image-receiving medium, and a cleaning step of removing the residual toner by scraping off the toner remaining on the photosensitive body after transfer with a cleaning blade placed in contact with the photosensitive body, wherein the toner described above is used as the toner.

This application is based on Japanese patent application serial no. 2006-151467, filed in Japan Patent Office on May 31, 2006, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A toner containing toner particles, comprising microparticle-deposited toner particles carrying polymerization microparticles having a particle diameter of 100 to 2,000 nm deposited on the surface of primary polymerization particles having a particle diameter of 3 to 12 μm in an amount of 80 pieces or more with respect to 100 pieces of the toner particles.

2. The toner according to claim 1, wherein the volume-average particle diameter of the primary polymerization particles is 5 to 10 nm.

3. The toner according to claim 1, wherein the number-average particle diameter of the polymerization microparticles is 200 to 800 nm.

4. The toner according to claim 1, wherein the primary polymerization particles and the polymerization microparticles contain resin components substantially similar in composition.

5. The toner according to claim 1, wherein the circularity of the primary polymerization particles is 0.970 or more.

6. The toner according to claim 1, wherein the primary polymerization particles and the polymerization microparticles are particles obtained by suspension polymerization.

7. The toner according to claim 6, wherein the polymerization microparticles are particles obtained as a by-product of the suspension polymerization.

8. A method of producing toner particles, comprising heating and agitating a particle mixture containing primary polymerization particles having a volume-average particle diameter of 5 to 10 μm derived from a main product of suspension polymerization and polymerization microparticles having a particle diameter of 100 to 2,000 nm derived from a by-product of the suspension polymerization at a predetermined temperature, allowing deposition of the polymerization microparticles on the surface of the primary polymerization particles.

9. The method of producing toner particles according to claim 8, wherein the predetermined temperature is 30 to 50° C.

10. An image-forming apparatus, comprising a photosensitive body where an electrostatic latent image in a particular image is formed by photoirradiation, a developing device of forming a toner image by supplying a toner onto the surface of the photosensitive body carrying the electrostatic latent image formed, a transfer device of transferring the toner image onto an image-receiving medium, and a cleaning device of removing the residual toner by scraping off the toner remaining on the photosensitive body after transfer with a cleaning blade placed in contact with the photosensitive body, wherein the toner according to claim 1 is used as the toner.

11. An image-forming process, comprising an electrostatic latent image-forming step of forming an electrostatic latent image in a particular image on the surface of a photosensitive body by photoirradiation, a developing step of forming a toner image by supplying a toner onto the surface of the photosensitive body carrying the electrostatic latent image formed, a transferring step of transferring the toner image onto an image-receiving medium, and a cleaning step of removing the residual toner by scraping off the toner remaining on the photosensitive body after transfer with a cleaning blade placed in contact with the photosensitive body, wherein the toner according to claim 1 is used as the toner.
